(19) United States
(12) Patent Application Publication
(10) Pub. No.: US 2003/0172108 A1
(43) Pub. Date: Sep. 11, 2003

(54) System for providing multimedia file

(76) Inventors: Joshua Paul, Los Angeles, CA (US); Houman Shekarchi, Los Angeles, CA (US)

Correspondence Address: Squire, Sanders & Dempsey L.L.P., 14th Floor, 801 S. Figueroa Street, Los Angeles, CA, 90017-5554, US

(21) Appl. No.: 10/091,781

(22) Filed: Mar. 5, 2002

(51) Int. Cl. G06F 15/16

(52) U.S. Cl. 709/203; 709/219

(57) ABSTRACT

This invention is directed to providing compound multimedia presentations on a client side that interacts with a host server connected to the client side by a network. The multimedia files used in the presentation may be embedded in a portable storage medium adapted to operate with the client side and communicate with the host server. The accessibility of the multimedia files on the client side may increase the rate of presentation to the user. The host server may also control and direct the multimedia files in the portable storage medium.

### BACKGROUND OF THE INVENTION

1. Field of the Invention

This invention provides a multimedia system capable of providing interactive multimedia presentations that may be customized and updated quickly despite bandwidth limitations across the Internet.

2. General Background and State of the Art

Internet Server applications have evolved to allow a user to access and interact with multimedia files over a network connection. To accomplish this, a multimedia file is transmitted over the Internet to a user's computer system for presentation. Multimedia files may be presented in many formats such as text, music, sound clips, graphics, three-dimensional images, animated graphics, pictures, video clips, virtual reality, and full-motion video. The size of a multimedia file can vary widely depending on its format. For example, a page of text may use 3 Kb to 5 Kb of storage, scanning that same page of text into an image format may use 50 Kb or more. Video may take up millions of bytes (megabytes or MB) or even thousand of millions of bytes (gigabytes or GB) of memory.

As multimedia files become more sophisticated in sound, video, animation, and 3-D objects, these files may become more life-like and interactive. The size of these multimedia files may grow to be hundreds of megabytes or more. With limited bandwidth connections through the Internet, transferring these large multimedia files through the Internet can take a long time and congest the Internet.

Each user's bandwidth capacity may vary widely depending on the user's type of connection and network. As a result, the time required for a user to download a large file may vary. For instance, Ethernets typically have a bandwidth of 10 megabits per second (Mbps), whereas bandwidth of a dial-up modem ranges from 9.6 to 56 kilobits per second (Kbps). A 10 MB multimedia file may take 20 seconds to download over Ethernet, whereas that same file may take an hour to download using a 56 Kbps dial-up modem.

Virtual reality is an example of a large file with intensive application. Virtual reality allows an Internet user to walk through a three dimensional world, pick up objects, examine them, and go to other Internet locations by flying or walking through doors. For greater realism, graphics and video files may be added to this world as well. As more graphics and video files are added, the virtual world multimedia file may become very large.

A user may visit a virtual world like any other Internet site on the site on the Internet. The multimedia file describing the virtual world may be downloaded to the user's computer. This may take less than a minute to well over several hours depending on the size of the virtual world and speed of the user's connection. After the file is downloaded to the user's computer, a processor in the user's computer may compute the geometry of the world based on the commands in the file and those received from the server. After the virtual world is computed, the user may interact with the virtual world.

Despite the appeal of applications such as virtual reality, the files associated with these applications can be very large. Having to download these large files over the Internet with the limited bandwidth can slow down the connection and diminish the user's experience. Accordingly, there is a need for a system that allows a user to access large multimedia files more quickly.

### INVENTION SUMMARY

This invention provides a multimedia system where local multimedia files are provided on the client side so that users do not need to download the multimedia file through the Internet so that multimedia files may be presented faster to a user. This may be accomplished by providing Internet users with local multimedia files in a portable storage medium (PSM). The local multimedia files may be accessed on the client side by installing the PSM into a client readable medium (CRM), such as a personal computer. A user may download smaller remote information files that correspond with the local multimedia files through a host server that enables the user to interact with the local multimedia files. The local multimedia files may be integrated with the remote information files to form a compound multimedia presentation that may be personalized for a user. Without having to download the larger multimedia files through the Internet, the compound multimedia presentation may be displayed to the user more quickly.

The PSM may include a PSM program that obtains a number of user specific information. The PSM program may determine the path through the user computer's file system so that the address where the PSM resides in the CRM may be obtained. The PSM program may also request the user to provide user identification (UID) information. If the PSM contains media identification information (MID), the PSM program may obtain this as well. Then the PSM program may transmit various information to the host server. The host server may be linked to a database that stores the data corresponding to the PSM.

With the address to PSM, the UID, and the MID, the host server may generate a plurality of Autonomous Media Objects (“AMOs”) based on the data stored in a database corresponding to the UID and MID. An AMO may function like a secretary that communicates between one entity to another entity. Entity may include servers, external interfaces such as keyboard and mouse, and other AMOs. The host server may then transmit a plurality of AMOs in a compound multimedia presentation to the CRM. The AMOs may access and manipulate the multimedia files in the PSM. This way, the user may access the multimedia files locally rather than downloading them from the host server.

The local multimedia files embedded in the PSM may be static or “read-only” so that they may not be altered. The PSM program's interaction with the host server and its subsequent generation of the AMOs may allow the display of a dynamic multimedia presentation by compounding the local multimedia files with the remote multimedia files to create a customized and updated multimedia experience for a particular user. Accordingly, Internet users may quickly access interactive multimedia presentations that may be customized and updated despite bandwidth limitations across the Internet.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a system view of a client side, a network, a host server, and a database.

FIG. 2 is a sequence diagram of communications amongst a client side, a network, a host server, and a database.

FIG. 3 illustrates an autonomous media object (AMO).

FIG. 4 illustrates a plurality of AMO interacting with one another.

FIG. 5 illustrates a quadrant system where a plurality of AMOs interact with each other.

FIG. 6 show a monitor displaying a compound multimedia presentation including two multimedia files.

FIG. 7 is a flow chart illustrating a method for operating the invention

FIG. 8 is a flow chart illustrating a method for generating an AMO.

FIG. 9 illustrates a network system for connecting a user to a host server

FIG. 10 illustrates another network system.

FIG. 11 illustrates yet another network system.

FIG. 12 illustrates a substitution component.

FIG. 13 illustrates a substitution.

### DETAILED DESCRIPTION OF THE PREFERRED EMBODIMENTS

This invention provides a multimedia system where Internet users may have faster access to a compound multimedia presentation. This may be accomplished through providing local multimedia files in the client side rather than downloading the multimedia files through the Internet. The local multimedia files may be embedded in a portable storage medium (PSM) where a user may access the local multimedia files using a client readable medium (CRM), such as a personal computer. Smaller files may reside remotely on a storage medium or database linked to the host server. The CRM may communicate with the host server so that the multimedia system may integrate the local file and the remote file together through an autonomous media object (AMO). That is, the AMO may reside within a compound multimedia presentation that includes the local, network, and remote files, which are presented as one cohesive multimedia file that has been tailored for a specific user. With the larger multimedia files residing locally, the speed of the accessing the compound multimedia presentation on the client side may be for the most part independent of user's bandwidth capacity.

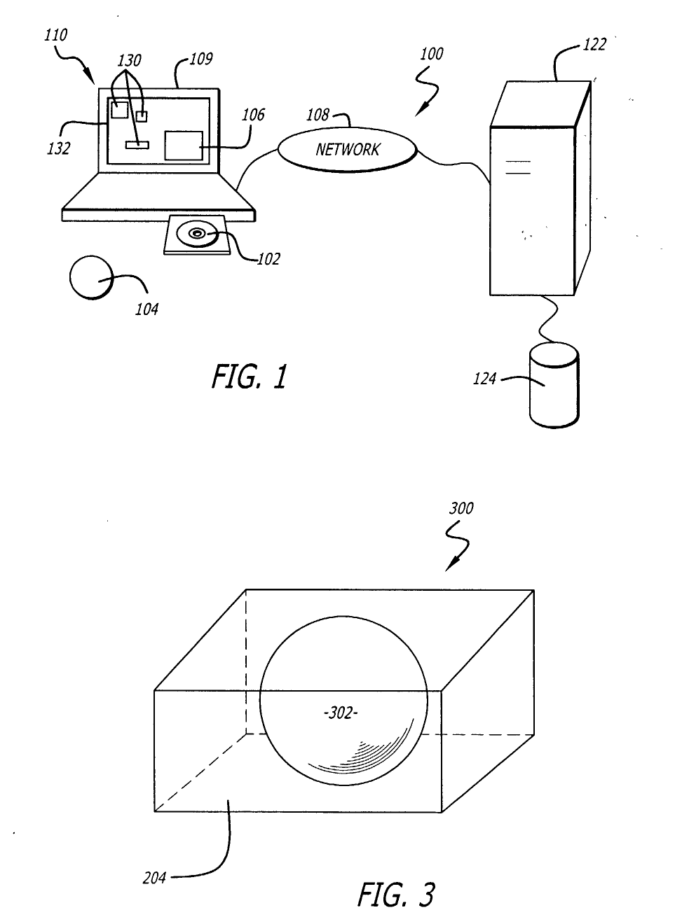

FIG. 1 illustrates a multimedia system 100 capable of providing Internet users faster access to multimedia files. The multimedia system 100 may include a CRM 110 having a driver 102 adapted to receive and read a PSM 104. The PSM 104 may include local file 106 that may be displayed onto a monitor 109 once it has been read by the driver 102. The local content on the PSM 104 may include multimedia files and a PSM program. Once the multimedia files are embedded into the PSM, they may be static, i.e., the multimedia files in the PSM may not be altered. The PSM program may include routines that allow the PSM 104 to interact with the CRM 110 and with a host server 122. For example, the PSM program may ascertain the address where PSM resides in the CRM, and this address may be forwarded to the host server 122. The PSM program may retrieve the media identification information (MID) for the PSM and forward this information to the host server 122 as well. The PSM program may also query the user for the user identification (UID) and forward this information to the host server 122. The PSM 104 may be any type of a storage device that can store multimedia files such a compact disc, DVD-ROM, CD-ROM, or any other storage device that may be developed in the future.

A user may access the multimedia files residing in the PSM 104 in a variety of ways. For example, a user may directly access the multimedia files residing in the PSM 104 using the driver 102. Alternatively, the PSM program may direct the CRM 110 to connect first to a host server 122 so that the user may interact with the multimedia files residing in the PSM 104. In the later example, an AMO may allow the user to view certain portions of the multimedia files residing on the PSM 104 that may be not be viewable without the AMO.

The host server 122 may be linked to a database 124 that stores a remote file 130. The remote file may include data that corresponds with the multimedia files residing in the PSM 104. The remote file may be also a smaller multimedia file that may be combined with the larger multimedia files residing in the PSM, where the remote multimedia file is incorporated with the local multimedia files to present a tailored compound multimedia presentation for a particular user.

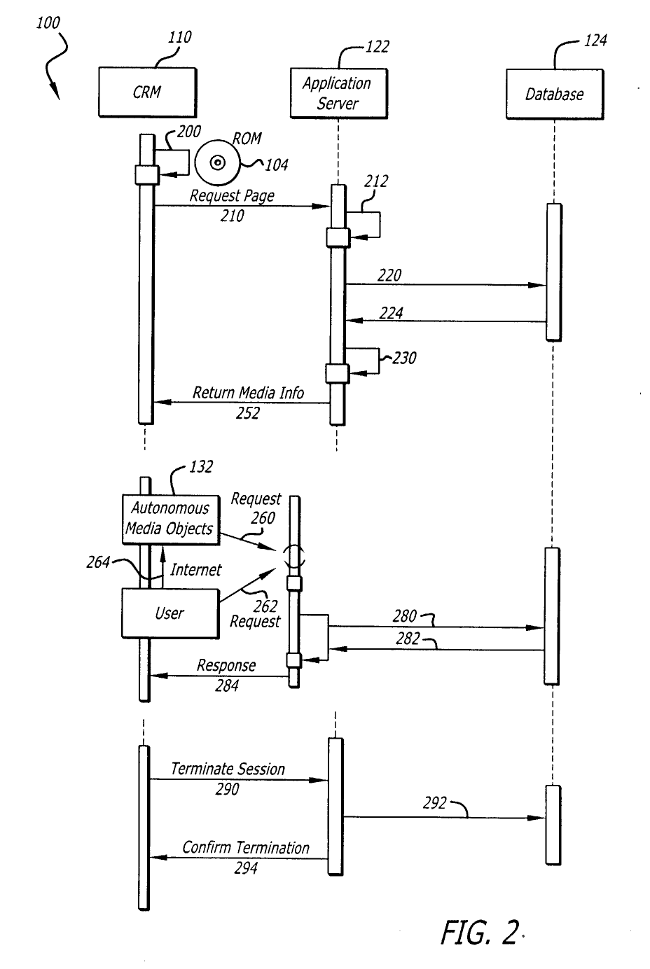

FIG. 2 illustrates the CRM 110, the host server 122, and the database 124 adapted to communicate with each other to distribute a compound multimedia presentation more quickly to a user. A user may insert the PSM 104 into the driver 102 (200) so that the CRM 110 may read the PSM 104. After the CRM 110 reads the PSM 104, a PSM program may initiate a request 210 to link with the host server 122. The PSM program may also detect media identification information (MID) for the PSM 104 and the address where the PSM 104 is located. Optionally, the PSM program may query the user for an UID to further assist in personalizing the compound multimedia presentation. In the communication 210, the PSM program may transmit the address of the PSM 104, the MID and optionally the UID to the host server 122. The host server 122 based on the MID may determine what type of multimedia files are on the PSM 104. In sequence 212, if the host server 122 recognizes the information received, then the host server 122 may store the address for the PSM 104 and MID and optionally the UID. In communication 220, the host server 122 may query the database 124 for data corresponding to the MID and optionally UID. The database 124 may return the requested data corresponding to the MID, and UID if used, in communication 224. In sequence 230, with the data received from the database 124, the host server 122 may generate a plurality of AMOs, using the stored PSM address, UID, and MID to aid in their initialization sequence. The host server 122 may then generate a plurality of AMOs 132 using portions of the requested data from the communication 224 and then render a compound multimedia presentation embedded with a plurality of AMOs 132. The host server 122 may then provide the compound multimedia presentation to the CRM 110 through the communication 252.

Within the compound multimedia presentation there may be a plurality of AMOs 132 that allow a user to interface with the presentation. After the CRM 110 connects to the host server 122, the host server 122 may generate a plurality of AMOs 132 that send and receive messages between different entities. As illustrated in FIG. 3, an AMO 300 may include data 302 secured within a number of methods 304. The data 302 may include Asset, Asset Matte, Board, Clickspot, ID, Illustration, Lifespan, Location, Metadata, Note, Notification, and Target. The methods 304 may include Act, Activate, Deactivate, Display-A, Display-B, Illustrate, Notify-A, Notify-B, Register, Swap, and Sync.

Within the data 302, Asset may be a location where the multimedia file resides both locally, on the local network, and/or remotely for an AMO to use. Asset Matte may allow the AMO to display the obtained Asset in a compound multimedia presentation without infringing the display of other AMOs obtained Assets. Board may allow an AMO to associate itself to one group of AMOs within a plurality of groups. This may be done using an identifier for an AMO when placed into a compound multimedia presentation that may include both local and remote multimedia files. Clickspot may be a coordinate system that allows the AMO to interpret the user's interaction, such as user's mouse movements. ID may be a unique identifier for an AMO so that that the AMO may be later identified. Illustration may be guidelines that allow the AMO to generate shapes that may be perceived by a user. Lifespan may be the length of time that the AMO may remain active. Location may be the location where the AMO displays its obtained Asset on the monitor 109. Metadata may be additional data that may be needed for an AMO to perform its function. Note may be a Notification to which an AMO may respond. Notification may be a structured set of data that may be sent by an AMO. Target may be an identification for another AMO to allow a passing of a Notification.

Within the methods 304, Act may be a function that takes a parameter of a Notification and may cause the AMO to use the parameter to comply with a request from another AMO. Activate may enable the AMO to accept the Notification and perform the task in the Notification. Deactivate may disable the AMO from acting on a Notification. Display-A may cause the AMO to present its obtained Asset at its Location. Display-B may cause the AMO to display a text string at its Location. Illustrate may cause the AMO to generate a shape based on the Illustration. Notify may cause the AMO to send its Notification to another AMO. Register may send the AMO to another AMO for recording of its existence. Swap may replace the AMO's Asset with another Asset. Sync may cause the AMO to cue a multimedia file associated with an Asset to a provided time parameter, if the multimedia file is time based.

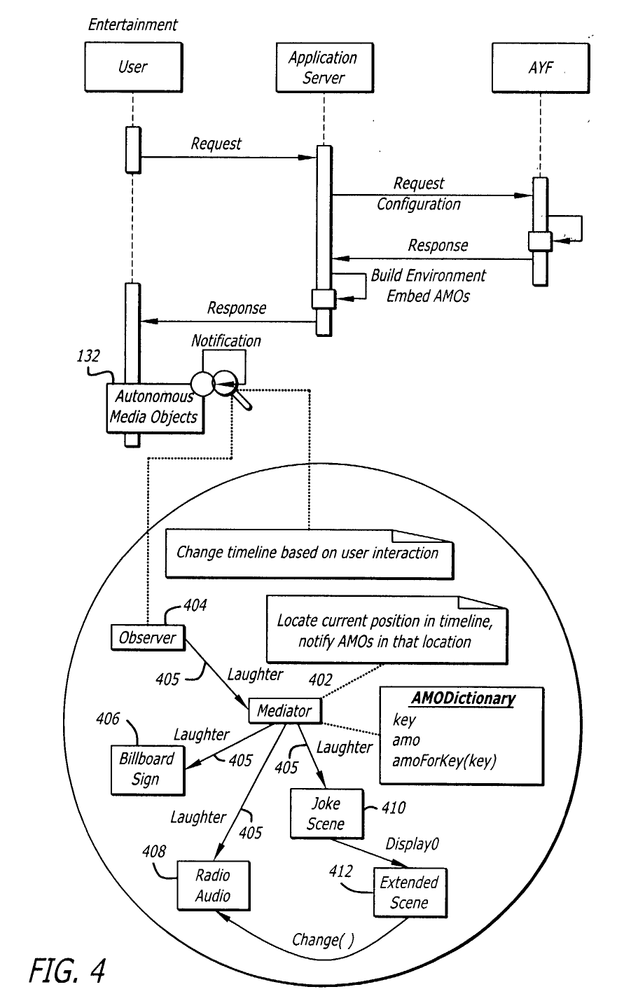

FIG. 4 illustrates the plurality of AMOs 132 interacting with one another to generate a compound multimedia presentation 400 that changes the presentation based on a user's interaction. The compound multimedia presentation 400 may include a plurality of AMOs that communicates with each other or through a mediator AMO 402. To change the multimedia presentation, the observer AMO 404 may recognize the user's interaction. For example, the observer AMO 404 may recognize user's mouse click which may indicate that user has found the currently displayed presentation humorous. Based on this user interaction, the observer AMO 402 may send its Notification 405 within the data 202 to the mediator AMO 402. The mediator AMO 402 based on the Notification 405 may determine which AMOs within the compound multimedia presentation 400 are active to receive the Notification 405. Then the mediator AMO 402 may pass the Notification 405 to the active AMOs 406, 408, and 410, for example. The active AMOs may then receive the Notification 405 and if the Notification corresponds to the Note in the data 202 for each respective AMOs, the AMO may parse the Notification. That is, the AMO with the corresponding Note in data 202 may read the information contained in the Notification 405 and perform the function as set forth in the Notification 405. For example, the mediator AMO 402 may send the Notification 405 to communicate with active AMOs 406, 408, and 410, where only AMO 410 has a Note within the data 202 of the AMO 410 that corresponds to the Notification 405. As such, the AMO 410 may send its Notification in data 202 to its Target within the data 202 of the AMO 410. This way, the Target within the data 202 of the AMO 410 may allow the AMO 410 to communicate with an extended scene AMO 412 so that the AMO 412 may display its multimedia file obtained through its Asset in data 202. Accordingly, user's interaction may cause the extended scene AMO 412 to display its multimedia file that would not otherwise have been presented had the user not interacted.

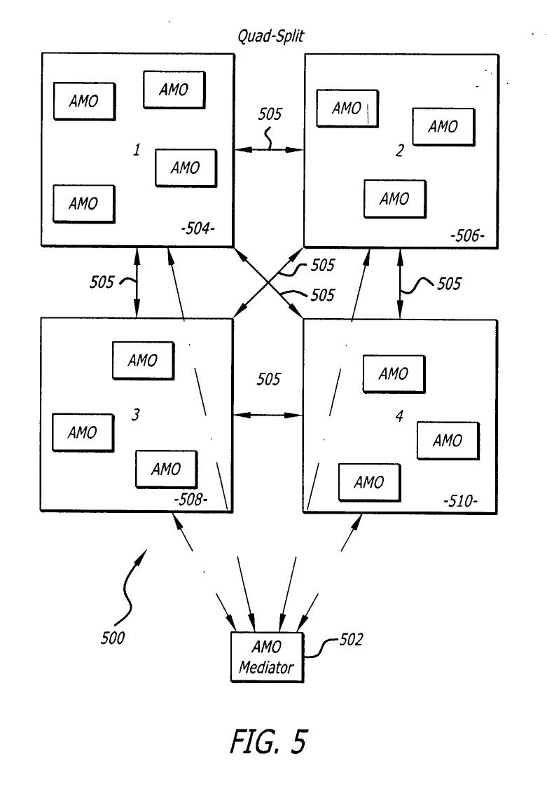

FIG. 5 illustrates a quadrant system 500 including a mediator AMO 502 communicating with a plurality of AMOs that may also interact with each other. The mediator AMO 502 may control and direct the operation of the plurality of AMOs. A user may interact with the plurality of AMOs in each quadrant to affect the multimedia presentation. The plurality of AMOs may be divided into a number of quadrants, such as four quadrants 504, 506, 508, and 510 where each quadrant may represent a viewable area on the monitor 109 of the CRM 110. The AMOs in one quadrant may communicate with AMOs in other quadrants. Within each quadrant there may be several AMOs that communicate with each other as well. For example, in the quadrant 504, there may be four AMOs that may communicate with each other and these four AMOs may communicate with the AMOs in the quadrants 506, 508, and 510.

The quadrant system 500 may be used for a variety of applications such as in an entertainment presentation. For example, the quadrants 504 through 510 may show different locations occurring at the same time. This may be for scenes involving a murder mystery where a detective is trying to find the killer from a number of possible suspects. In quadrant 504, the detective's movements may be followed. In the other three quadrants, movements of three possible suspects may be followed where suspect A, suspect B, and suspect C may be viewed from quadrants 506, 508, and 510, respectively. Each quadrant may operate as the compound multimedia presentation 300 as discussed above where each quadrant may communicate with other quadrants through Notifications 505. The compound multimedia presentation may, however, vary depending on the user's interaction such as time of the day the user is watching the presentation. For instance, if the user is viewing the presentation in the morning, based on the MID of the PSM 104, the data returned in communication 224 may cause the personalization of the compound multimedia presentation to where the suspect A is the killer. On the other hand, if the presentation is viewed in the evening, the data returned in communication 224 may cause the personalization of the compound multimedia presentation to where a new suspect D is introduced that alters the outcome of the murder mystery. Such actions may be prompted by the user or by the Notification sent by an AMO.

The compound multimedia presentation may be altered in many ways. For example, the mediator AMO 502 may send a Notification 505 to AMOs that are active to indicate that the compound multimedia presentation is being viewed in the morning. Then one or more AMOs in the quadrants may parse the Notification 505 and function according to the data contained in the Notification 505. If the compound multimedia presentation is viewed in the evening, then the mediator AMO 502 may send Notification 505 to AMOs with different data contained in the Notification so that the outcome of the murder mystery may be different.

There may be a variety of ways of altering the outcome. For example, based on the information received in the communication 224 the host server 122 may generate AMOs with different internal data 202 which may cause the AMO to manipulate the multimedia files in the PSM 104 differently. For example, an AMO may be initialized with the Location in data 202 of X that may cause the display of its obtained multimedia file on monitor 109 in a certain coordinate. By initializing the AMO with a different Location of Y the AMO may display its obtained multimedia file in a different coordinate. Another way is to use Swap in the methods 204 to change the obtained Asset of an AMO. After an AMO has been embedded into a compound multimedia presentation it may be informed to obtain a different multimedia file than it was initially generated to obtain. This may cause the AMO to manipulate a different multimedia file in the same manner that was intended for the original multimedia file.

The various scenarios developed above may reside on the PSM 104 or at a remote location, such as in the host server 122. The various situations may constitute various “layers” within the multimedia files residing in the PSM 104. Each layer may represent a different filming sequence. To extract different sequences, an AMO residing in the quadrant 504 may extract a certain scene from a particular layer. Later in time, when the AMO residing in quadrant 504 receives a Notification, the same AMO may extract a different sequence from a different layer to display. The other AMOs may operate in a similar manner. This way, a user may view different sequence of events generated in real-time that may be altered depending on the inputs of the user.

The CRM 110 may send messages periodically to the host server 122 to request or submit additional data. This data may be used to customize the interaction with the user. A multimedia file residing in PSM 104 displayed within a compound multimedia presentation may send a request 260 to the host server 122. The request 260 may be based on a predetermined time interval programmed into a multimedia file, receipt of a Notification by an AMO, or an interaction of a user. A user may prompt the CRM 110 in request 262 for additional data to communicate with the host server 122. Upon receiving the request in communications 260 or 262, the host server 122 may examine the request to determine the appropriate actions to take. For example, if a user decides to purchase an item while viewing one of the quadrants, the user may use a mouse click onto the item such as a shirt. If additional data from the database 124 is needed, such as the color for the shirt, the host server 122 may send an appropriate request in communication 280 to the database 124. The database 124 may respond in communication 282 with the corresponding data, such as the color for the shirt. The host server 122 may then send the requested information to the CRM 110 in communication 284. The data that is returned through communication 282 may be integrated into a Notification format for an AMO. Alternatively, the server 122 may return an additional compound multimedia presentation with formatting appropriate for the information requested in communication 260 or 262.

The communications 210 through 284 may continue until the current session is terminated in communication 290. The session may terminate for a variety of reasons. For example, the compound multimedia presentation may come to a conclusion when the murder mystery is solved or the user turning off the CRM 110. The host server 122 may inform the database 124 to finalize the current session in communication 292 to provide parameters to used in later personalized compound multimedia presentations. The host server 122 may also send a confirmation of the termination in communication 294.

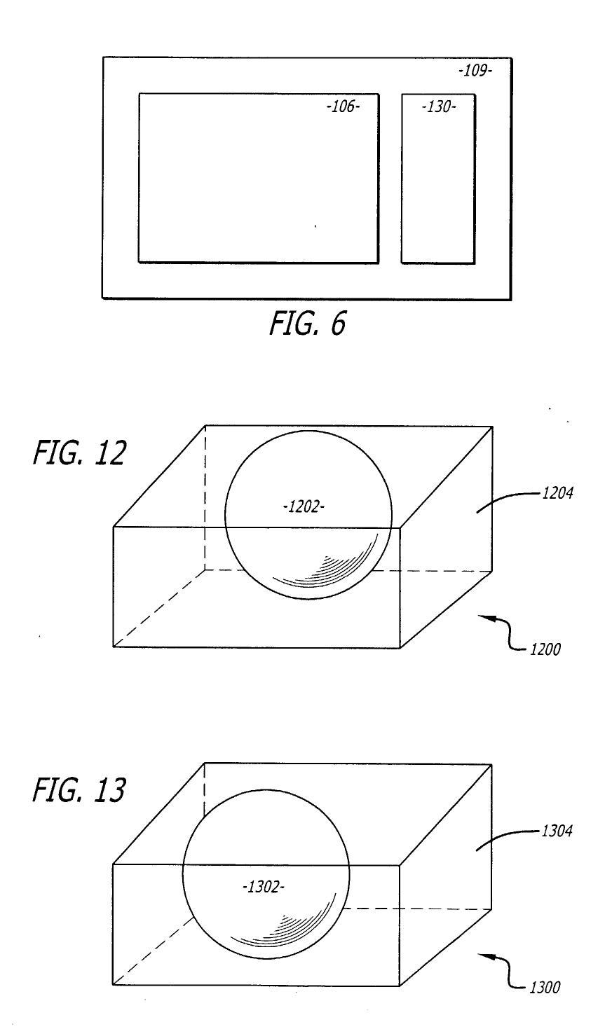

The queries made in requests 260 and 262 may allow the host server 122 to provide up-to-date data for use by the plurality of AMOs 132 in the compound multimedia presentation. For example, if the PSM 104 is a catalog of consumer products, then the request may include queries for up-to-date pricing and/or stock availability. This way, as illustrated in FIG. 6, AMO using its Asset in the data 202 may obtain a first multimedia file 106 and using the Display in methods 204 to cause the first multimedia file 106 to appear on the monitor 109 at the Location in data 202. A second multimedia file 130 may appear on the monitor 109 as well with up-to-date pricing and availability provided by the host server in communication 284. In short, the AMO 130 may send a request 260 to the host server 122 and based on the response 284, the AMO 130 may parse the response 284 to present the text on the monitor 109 at the Location described in the data 202.

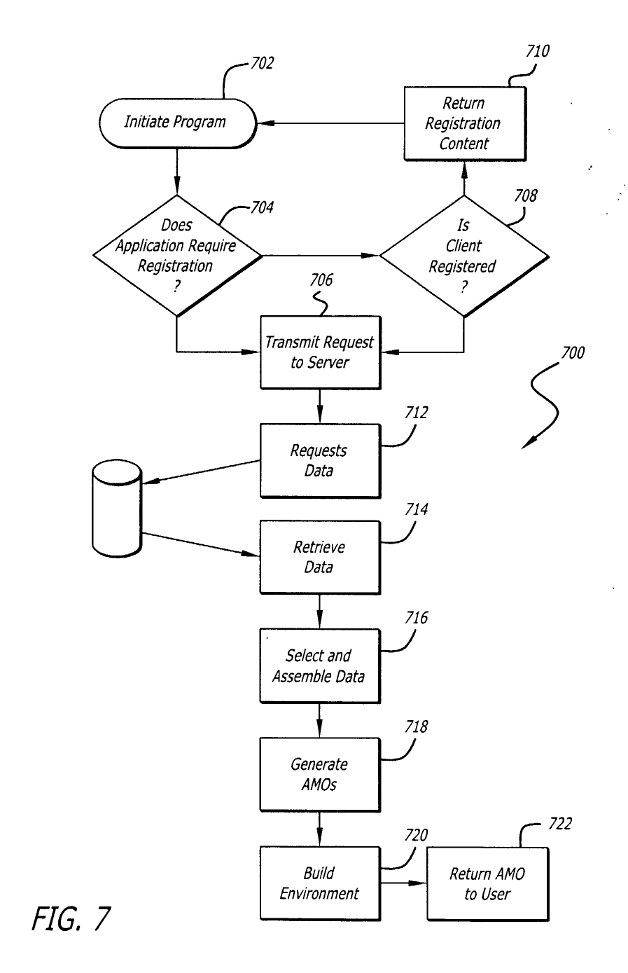

FIG. 7 illustrates by way of example a method 700 for operating the invention. In sequence 702, the PSM program may be initiated by inserting a PSM 104 into a driver 102. In decision block 704, the program may determine if a user needs to register or not depending on the application. A user may need to register in certain applications where it is user specific so that the resulting compound multimedia presentation is tailored for that specific user. For example, the same multimedia file may be embedded into a number of PSMs 104 where some of the PSMs may have different MID than others. This way, users with different MID on their PSMs 104 may experience the same multimedia file but a different remote file 130 corresponding to MID in the PSM. For instance, the invention may be used for educational purposes, where PSM's for administrators may be given a different MID than PSM's for the students. Based on the MID distinction between the administrators and the students, the administrators may have access to some features that are not available to the students. For example, the administrators may have access to questions and answers, but the students may only have access to questions to prevent them from cheating.

If the PSM program does not require a registration, then the PSM program may transmit a message to the host server 122 in communication 706 that no registration is required. If the PSM program does require a registration, then the program in decision block 708 may inquire whether the user is already registered. If the user is registered, the PSM program may transmit the registration information in communication 706 to the host server 122. If the user is not registered, the PSM program may request the host server 122 to return the registration file as in operation 710. This may require the PSM program to reinitiate in operation 200.

In communication 706, the host server 122 may store the address of the PSM 104 as well as the MID and UID. In block 712, the host server 122 may request the database 124 for data corresponding to the UID and MID. The database 124 may then retrieve the corresponding data and forward it to the block 714. In block 716, the host server 122 may parse the data received from the database 124. In block 718, the host server may generate the plurality of AMOs 132, as discussed above. The host server may render a compound multimedia presentation in block 720 in a variety of methods, such as embedding the corresponding data, and a plurality of AMOs 132. The rendering may also include personalizing a list of possible conclusions, determining whether the user has administrative permissions, determining whether multimedia files embedded on the PSM 104 are permitted to be used, or imposing owner and application rules on the compound multimedia presentation. In block 722, once the environment and the AMOs are generated, this may be returned to the user.

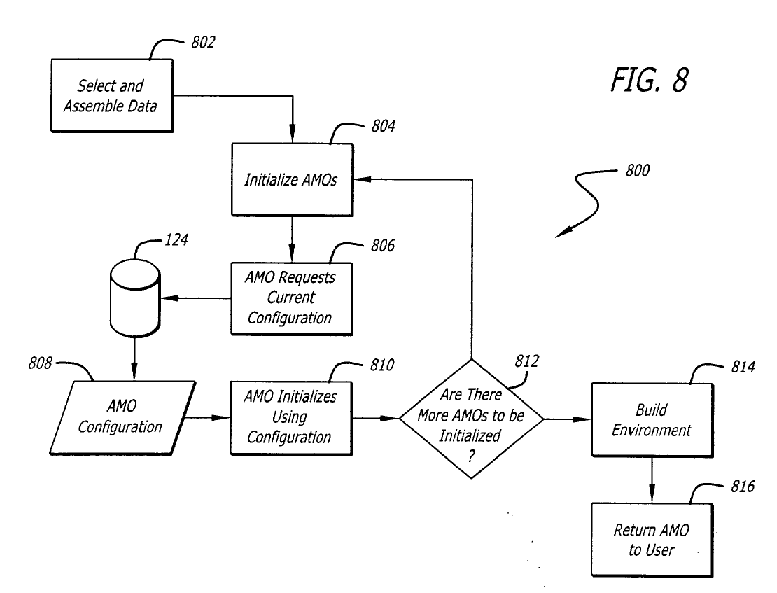

FIG. 8 illustrates by way of example a method 800 for generating an AMO. In block 802, the host server 122 may parse the data it received from the database 124. The data may the information the host server 122 requested in block 716 using the MID. Generating the AMO in communication 718 may require communication with the database 124. In operation 804, the host server may generate a plurality of AMOs 132. This may be accomplished by initializing an AMO with additional data 808 stored in the database 124 for each AMO. The additional data may allow the host server 122 and the AMO to initialize a unique configuration 808 that may include one or more of the following by checking to determine whether: Asset is the location/address of a multimedia file in the PSM or a multimedia file on the host server 122, or another computer; Asset Matte is the location of a multimedia file in the PSM or a multimedia file on the host server 122 or even another computer; Board is a sequence of data used as an identifier for one AMO to associate itself to another AMO with an identical Board, which may allow for “grouping”; Clickspot is a coordinate system that may allow the AMO to interpret the user's interaction; ID is a unique identifier for an AMO and may be created through an algorithm that may use the ethernetID of the host server 122 and the current time of day; Illustration is the guidelines such as bounds, color, fill, height, thickness, and width that allow the AMO to generate shapes; Lifespan is a length of time that the AMO may remain active; Location is a coordinate system relating to the monitor 109; Metadata is additional information such as a sequence of data that may be displayed to a user upon interaction with the AMO, and this sequence of data may be related to the multimedia file obtained through the Asset; Note is a Notification which an AMO may use to compare to other Notifications to determine whether or not the AMO should parse the other Notifications; Notification is a structured set of data, such as an XML file, that may be sent by an AMO to another AMO; and Target is an identification of another AMO to allow the passing of one AMO's Notification to the AMO associated with the identifier.

The database 124 may return an up-to-date configuration in operation 808. An AMO may then be initialized using the configuration in operation 810. Then, in decision block 240, the host server 122 may ask whether more AMOs need to be initialized. If there are, the host server 122 may return to operation 232 to initialize other AMOs.

The AMO may allow for bandwidth scaling in order to take advantage of increasing bandwidth capacity in the future. With greater bandwidth capacity, the multimedia files may reside in the database 124 rather than in the PSM 104. Bandwidth capacity may vary for each user so that the time-delay in accessing multimedia files through the host server and downloading the multimedia files to the CRM 110 may vary for each user. To minimize the time-delay, AMOs may adapt the multimedia file obtained using its Asset in data 202 transmitted to the CRM 110 depending on the bandwidth capacity for clients. For example, the PSM program may detect and/or query the client about the client's bandwidth capacity. Depending on the capacity, the AMOs may be initialized with different data 202 to change the amount and type of files sent to the client to minimize the delay involved in the transmission of the file from the host server 122 to the CRM 110.

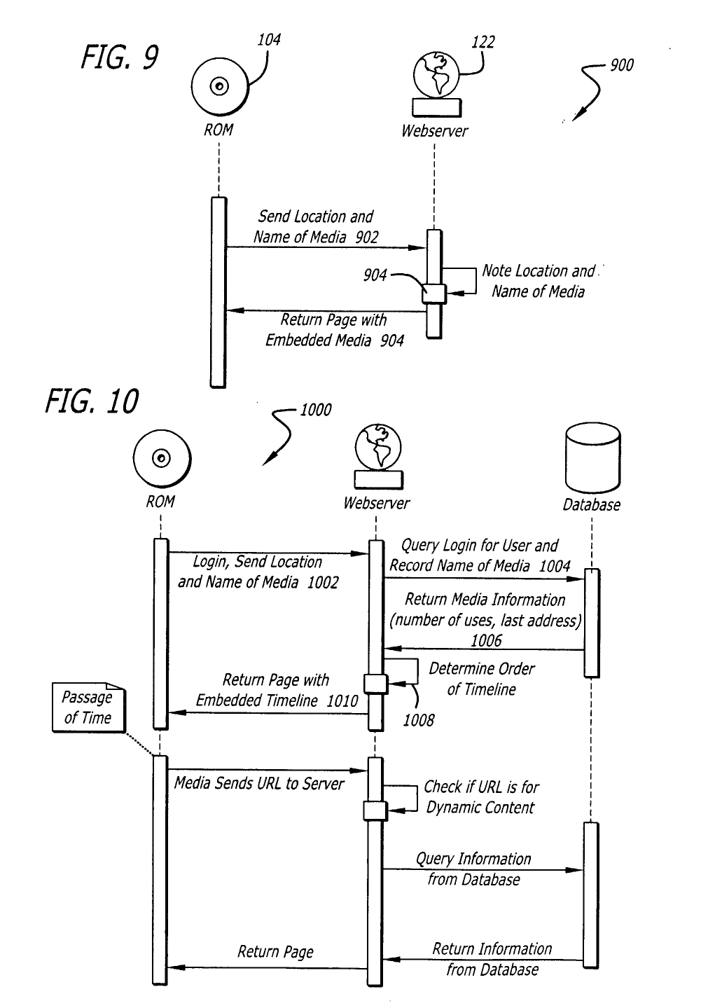

FIG. 9 illustrates a network system 900 for connecting a user to the host server 122 with a slow network connection without impairing the user's experience. After the CRM 110 reads the PSM 104, the PSM program may initiate a request 902 to link with the host server 122. In sequence 904, if the host server 122 recognizes the information received, then the host server 122 may store the MID for the PSM 104 and UID. Based on the MID and UID, the host server may return 904 the compound multimedia presentation to the CRM 110, but the user may not be able to interact with the host server 122 while the compound multimedia presentation is running on the CRM 110. The compound multimedia presentation may limit the user's ability to access new files during the presentation's display. But with bulk of the multimedia files residing in the PSM 104, the user may be able to jump around to different parts of the presentation through interaction with the plurality of AMOs 132 without having to download a new presentation. The ability to jump around may be called “nonlinear progression.” This way, no buffering may be needed to download a new presentation and subsequent access the new presentation locally on the CRM.

As bandwidth capacity increases in the future retrieving certain files from a remote server over the Internet may be just as quick as retrieving the same file from a local storage device on the client's computer. The storage of various algorithms, which may include encryption, voice prints, and texture maps, and programs locally on the client side may replace the static file. For example, programs that allow for the creation and manipulation of virtual characters and virtual worlds may reside in the PSM 104.

Multimedia files may be created in real time using virtual characters and environments and be used in a compound multimedia presentation for a particular client using AMOs. A writer may create a script in the appropriate language or program that includes various dialogues and character movement commands. The script may reside on the database 124. When the CRM 110 receives the script from the host server 122, the AMOs may, in response to the script, obtain and configure the virtual characters and their virtual environment to play out the script through the use of data 202 and method 204. AMOs may allow the writer to change the script from a remote location; so that the environment, characters or dialogue may be different each time the user views the compound multimedia presentation.

The network system 900 may use the plurality of AMOs for a number of applications such as entertainment, surveying, education, and marketing. In the entertainment industry, television and movie programmers may have virtual characters act out a script to test audience reactions. Then, depending on certain reactions, the writer may revise the script. In this way, the invention may minimize the uncertainty and financial risk involved in recording a television program or movie with some understanding of audience's reaction. Using a plurality of AMOs, the network system 900 may generate different multimedia presentations in real-time depending on the user's input, for example.

The plurality of AMOs 132 may also allow third parties to display information on the compound multimedia presentation. For example, while the user is watching a presentation about skiing, the presentation may include a third party logo placed over the skier's helmet inviting the user to visit the third party's web site or to purchase the item.

FIG. 10 illustrates a network system 1000 that may be adaptable so that a compound multimedia presentation sent to the user by host server 122 may change without replacing the PSM 104 in possession of the user. The adaptability feature may offer the user a different experience each time the user logs into the host server 122 using the same PSM 104. For example, the user may receive different messages depending on the number of times the user has logged on before. The user may also receive different messages depending on past activity or rules set forth by the owner of the multimedia files residing on PSM 104. For instance, the network system 1000 may place a new file, such as new conclusions, on the server after a user has received the PSM 104. When the user logs in, the user may choose or the server may present a different ending to a movie or a television program than the one seen before.

To recognize a specific user, the PSM program may request the user to login as described above in operations 702 through 722 in FIG. 7. In communication 1002, the PSM program may send to the host server 122 the login information, along with the address and MID of the PSM 104. In communication 1004, the host server 122 may query the database 124 with the UID as well as the MID. The database 124 may return the data received in communication 1006 to the host server. This information may be the date and time, the number of times the user accessed the host server 122, and a list of multimedia files that reside in PSM 104. The data received in communication 1006 may also include prior conclusions the user may have seen already. In sequence 1008, the host server may generate the AMOs and may determine the operation of the plurality of AMOs 132. The host server can then render a compound multimedia presentation. In communication 1010, the host server 122 may send the compound multimedia presentation with the embedded AMOs to the user for display.

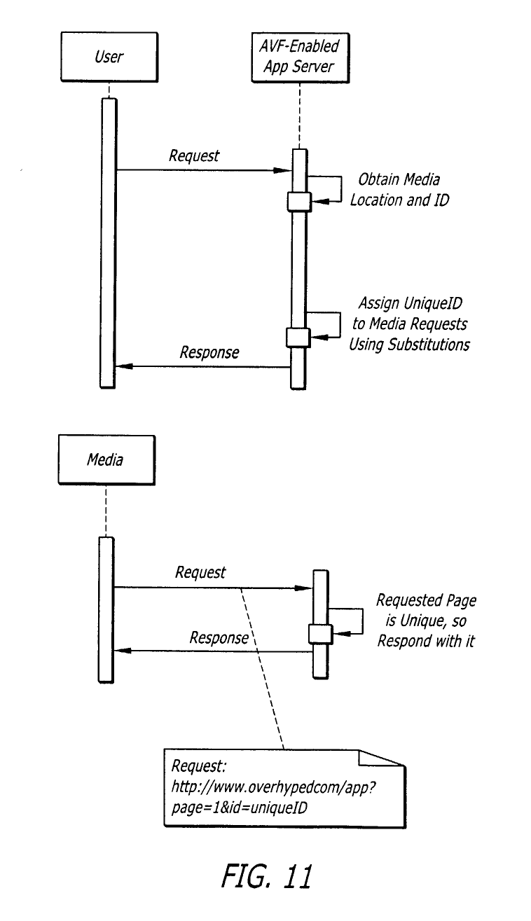

FIG. 11 illustrates a network system 1100 where substitution may be used to override the embedded requests that are statically encoded within the multimedia files in the PSM 104 so that the requests may be altered. As illustrated in FIG. 12, a substitution component (SC) 1200 may include a data 1202 within a method 1204. The data 1202 may include an AMO as discussed above, Flag, ID, Owner, and an array of substitute 1300. The Flag may indicate whether or not the multimedia file obtained by the AMO using its Asset in data 202 is going to be making a request to the host server 122. The ID may be a unique identifier for the SC 1200. The Owner may be a user that may control or change information contained in the array of substitute in the data 1202. The methods 1204 may include an assign request that may be made to the host server 122.

A substitute may include a sequence of data values to override the embedded messages that are statically encoded within the multimedia files in the PSM 104 so that the message may be altered. As illustrated in FIG. 13, a substitute may include a data 1302 encapsulated within a method 1304. The data 1302 may include a message, target, time, and override. The method 1304 may include a format that may parse the message and the override contained in the data 1302 to provide the information to the SC 1200.

When a SC 1200 assigns a request, it may direct each substitute 1300 contained in its array of substitutes within the data 1202 to use the Format in the methods 1304. The direction may cause each substitute 1300 to parse the Message and the Override contained in data 1302 and provide the result of SC 1200 in a formatted sequence of data, so that SC 1200 may assign the formatted sequence of data as a request. Put differently, a compound multimedia presentation may include a number of AMOs, where some of the AMOs may be wrapped within a SC 1200. The AMOs may be capable of locating a multimedia file that may be residing locally on a PSM or remotely on a database 124. Accordingly, the compound multimedia presentation may be comprised of a number of multimedia files that are displayed on the monitor 109 as the AMOs goes out and find the multimedia files.

The multimedia file may or may not make a request for additional information. For example, the request may be based on a predetermined time interval programmed into a multimedia file. If the request is made, the SC 1200 may intercept the request and if the SC 1200 has an override for the request, the override may be sent rather than the request. This way, if the multimedia file request for a video on a product number XXXX, SC 1200 may be used to provide for a video on a product number YYYY to be displayed in the monitor 109 to alter the request from the multimedia file.

By using the substitution 1300, both the Message and Override may be bound together into a sequence of data. This sequence of data may be returned to the SC 1200 for future use where the “Request A” has not occurred yet, and may never occur, but SC 1200 may recognize if “Request A” does occur. When this happens, SC 1200 may replace the “Request A” with “Request B” by assigning the sequence of data to the SC 1200. Therefore, if “Request A” does occur, the SC 1200 may replace the “Request A” with “Request B” that may be predetermined. This way, a request from a multimedia file such as “Request Pepsi” can be changed to “Request Coke” before the request gets sent from the monitor where the multimedia file is being sent to another AMO or the host server. The SC 1200 may be embedded into a compound multimedia presentation. Because the AMO obtains the multimedia file that is making the request and the AMO is “wrapped” in the Substitution Component, any requests from the multimedia file may be monitored and replaced if necessary.

The multimedia files in the PSM 104 may be preprogrammed to make requests. For example, a multimedia file of a video may be preprogrammed so that when the video has played longer than 3 minutes, a request may be made to a host server. The multimedia files may not be altered, as such the request may not be rewritten once the user is in possession of the PSM 104. By using the SC 1200 as a “wrapper” around the plurality of AMOs 132, a request made by a multimedia file obtained by an AMO using its Asset in its data 202 within the plurality of AMOs may be substituted by the AMO prior to the request leaving its domain. In other words, once the request has been assigned to the SC 1200, a request from a multimedia file may be replaced prior to the request from a multimedia file leaving the multimedia file's domain, provided that the multimedia file has been obtained by an AMO and the AMO is “wrapped” in the SC 1200.

By using the MID, the host server 122 may determine which multimedia files reside in the PSM 104, thereby allowing it to produce a SC 1200 to temporarily reprogram the requests made by the multimedia files residing in the PSM 104. By combining the MID with the UID, a host server 122 may render a compound multimedia presentation where a digitally identical multimedia files residing on two separate but identical PSMs 104 may make unique requests. This way, even though multiple identical PSMs may have digitally identical multimedia files, and those multimedia files may not be altered or their requests be reprogrammed, the requests made by each multimedia file in any compound multimedia presentation may be unique because an AMO may obtain the multimedia file through its Asset in data 202 and the AMO is “wrapped” in a SC 1200.

The multimedia files in the PSM 104 may be used for a variety of purposes. For example, the host server, based on UID of the user may adapt the presentation for a specific application depending on the user. This way, many users may receive the same PSM, but the presentation may be different for each user depending on the application. For example, the multimedia file may include a video showing a doctor using a tool to perform a surgery. This presentation may be used for several different purposes. First, the presentation may be for marketing the tools to prospective customers. Second, the presentation may be used for meeting continuing educational requirements for surgeons who want to learn a new technique or brush up on an old technique. Third, the presentation may be used in an educational institution to teach students how to perform the surgery. To distinguish between the multiple uses of the presentation, the host server may request a UID or an MID from the user. According to the UID or the MID received, the host server may request a data from the database, which is specific to the presentation. For example, in the marketing presentation, the data may include instructions on using the tool, specification, cost, and close up view of the tool. In the educational presentation for the surgeon and the student, the data may include more detailed information explaining the specific procedures used. The host server may integrate the data with an AMO 132 and send the integrated information to the CRM 110.

The security feature of the invention may be enhanced by using a Logic Hiding feature to make it more difficult for a sophisticated user to reverse engineer and extract information from a request sent to a host server 122 by a multimedia file. For example, the invention may enable adaptive testing materials. Whereas the multimedia files may reside in the PSM 104, a remote database may contain both the questions and answers for an exam. A request sent from a multimedia file in a compound multimedia presentation displayed on monitor 109 may be for various information and instructions, which may include the indicator for next question and answer. A user that may decipher this message may determine which question is next as well as the answer to the question. This may undermine the integrity of the testing materials. To prevent a user from deciphering the answers, the Logic Hiding feature may encode the request, such that the request may be readable by machines using hiding algorithms known in the art.

As another feature, the system may include a dynamic control feature that may enable an administrator to dynamically change the requests made by the multimedia files in the PSM 104. This may be accomplished through the use of the MID, an AMO, and the SC. For example, during the programming of a PSM 104, an enterprise may have mislabeled a product, even though the correct multimedia file is in the PSM 104. By using the MID to assemble a list of the multimedia files residing in the PSM 104, an administrator may set the sequence of data values to be used by the substitution 800 to override the embedded requests that are statically encoded within the multimedia files in the PSM 104 obtained by the AMO using its asset in data 202.

The system may be used in a variety of market segments such as in marketing, sales, education, and entertainment. One enterprise or a number of enterprises may use the same multimedia files for a variety of different purposes. These multimedia files may be sent to a user in a PSM 104. An enterprise may have many customers, where the same PSMs 104 may be distributed to all, even though the resulting compound multimedia presentation for each customer may be different. Multiple enterprises may use different segments of the same multimedia file for their respective objectives. In addition, over time, the enterprises may change the context and form of their presentations without having to replace the PSM.

Many enterprises may benefit from the system by placing multimedia files on the client side. For example, one enterprise may present a virtual reality shopping mall to market its products and services. In the virtual reality shopping mall, the enterprise may play audible music, exhibit videos and show different messages, which could reside on the client side. In addition, the enterprise may take advantage of virtual reality functions and allow the shopper to fly through the mall, opening doors, pick up different products, or interact with objects programmed inside the shopping mall. In another example, an enterprise may present a demonstration of the enterprise's products and/or services. In another example, an enterprise may present a survey incorporating multimedia file that may be sent to various individuals to obtain their opinions. In another example, an enterprise may design and distribute testing software that may incorporate multimedia files. The software may be directed to adaptive testing materials where the selection of a subsequent question may depend on the answer to the previous question.

While various embodiments of the application have been described, it will be apparent to those of ordinary skill in the art that many more embodiments and implementations are possible within the scope of this invention. Accordingly, the invention is not to be restricted except in light of the attached claims and their equivalents.

What is claimed is:

1. A method for interacting with multimedia files, comprising:
receiving a portable storage medium (PSM) having multimedia files adapted to interact with data that corresponds with a media identification (MID) information;
installing the PSM to a client readable medium (CRM) that transmits the MID information corresponding to the PSM to a host server that retrieves the data that corresponds with the MID, where the host server initializes a plurality of autonomous media objects (AMOS) using the data, where the host server renders a compound multimedia presentation while embedding the initialized AMOs;
retrieving the compound multimedia presentation to the CRM; and
interacting with the AMOs.

2. The method according to claim 1, further including:
storing the data into a remote database.

3. The method according to claim 1, where the PSM is embedded with a program that links the CRM to the host server.

4. The method according to claim 1, where the PSM is embedded with a program that queries for user identification number to personalize the compound multimedia presentation.

5. The method according to claim 1, where the plurality of AMOs communicate with each other, where the plurality of AMOs include a mediator AMO that directs notification to other AMOs.

6. A method for accelerating the presentation of multimedia files, comprising:
storing multimedia files in a portable storage medium (PSM) that is adapted to be read by a client readable medium (CRM), where the PSM has a media identification (MID) information;
determining an address for the PSM in the CRM;
communicating between the CRM and a host server that obtains data based on the media identification (MID) information; and
initializing a plurality of autonomous media objects (AMOs) based on the data corresponding to the MID information.

7. The method according to claim 6, further including:
transmitting the plurality of AMOs to the CRM; and
communicating between the plurality of AMOs and the host server.

8. The method according to claim 6, where the plurality of AMOs include a mediator AMO that has a directory of other AMOs within the plurality of AMOs.

9. The method according to claim 8, where each AMO includes a data within a method, where the data includes a note that responds to a matching notification from another AMO.

10. The method according to claim 9, where the plurality of AMOs include active AMOs that receive a notification, and if the notification corresponds to the note of an AMO within the plurality of AMOs, then parsing the notification to read the information contained in the notification and performing a function set forth in the notification.

11. The method according to claim 8, where the plurality of AMOs includes an observing AMO that recognizes an input, where if the input is detected then the observing AMO sends a notification to the mediator AMO that sends the notification to other AMOs to determined which AMOs are active, where the active AMOs with a note that matches the notification parses the notification.

12. A method for presenting multimedia files, comprising:
storing multimedia files in a portable storage medium (PSM) that is adapted to be read by a client readable medium (CRM);
obtaining a media identification (MID) information corresponding to the PSM;
communicating the MID information between the CRM and a host server that retrieves data that corresponds with the MID information from a database;
embedding portions of the data into an autonomous media object (AMO) through initialization of the AMO, where the AMO is adapted to integrate the multimedia files in the PSM, multimedia files on a network, and remote multimedia files, to generate a compound multimedia presentation.

13. A method for repurposing multimedia file, comprising:
including a sequence of data values to override embedded messages that are statically encoded within the multimedia files in a portable storage medium (PSM) so that the embedded message may be altered;
obtaining a statically embedded request within a multimedia file residing on a PSM;
obtaining a sequence of data values to override the embedded request;
substituting the sequence of data values for the statically embedded request by formatting a new sequence of data values;
assigning the new sequence of data values through a substitution component;
embedding an autonomous media object (AMO) into the substitution component;
transmitting the substitution component to a client readable medium where the PSM is located.

14. A method for controlling local media from a remote location, comprising:
embedding multimedia files in a portable storage medium (PSM), where the multimedia files include a first computer program;
communicating a media identification (MID) information corresponding to the PSM between a client readable medium (CRM) and a host server that is adapted to retrieve data stored in a database, where the data corresponds to the MID information;
parsing the data and embedding the result into an autonomous media object (AMO); and
exchanging messages between the CRM and the host server, where the host server is adapted to retrieve additional data corresponding to requests received from the CRM or multimedia files.

15. A method for displaying a sequence of events from multiple points of view, comprising:
creating multimedia files including multiple story sequences;
initializing at least one autonomous media objects (AMOs), where the AMOs contain instructions for extracting different parts of the multimedia files;
embedding the least one AMOs into a compound multimedia presentation; and
exhibiting the compound multimedia presentation on a display of a client readable medium (CRM);
communicating information between the at least one AMOs; and inputting to alter progression of a story.

16. A method for securing requests made by multimedia files, comprising:
obtaining a embedded request within a multimedia file;
obtaining a sequence of data values to override the embedded request;
substituting the sequence of data values for the embedded request by formatting a new sequence of data values;
encoding the new sequence of data values using an algorithm to a produce new series of requests;
assigning the encoded requests through a substitution component;
embedding an autonomous media object (AMO) into the substitution component;
transmitting the substitution component to a client readable medium (CRM).

17. A multimedia system capable of providing faster access to multimedia files, comprising:
a portable storage medium (PSM) having local multimedia files adapted to interact with remote data that corresponds with a media identification (MID) information; and
a client readable medium (CRM) that is adapted to read the PSM and transmit the MID information to a host server that retrieves the remote data from a database that corresponds with the MID information, where the host server initializes a plurality of autonomous media objects (AMOs) using the remote data and embeds the AMOs into a compound multimedia presentation.

18. The multimedia system according to claim 17, where the compound multimedia presentation includes a first multimedia file and a second multimedia file.

19. The multimedia system according to claim 18, where the plurality of AMOs include a first AMO that has a first data within a first method, where the first data includes a first asset and a first location, where the first method includes a first display, where the first AMO using the first asset obtains the first multimedia file and using the first display causes the first multimedia file to appear on a monitor of the CRM at the first location.

20. The multimedia system according to claim 19, where the plurality of AMOs include a second AMO that has a second data within a second method, where the second data includes a second asset and a second location, where the second method includes a second display, where the second AMO using the second asset obtains the second multimedia file and using the second display causes the second multimedia file to appear on the monitor of the CRM at the second location.

21. The multimedia system according to claim 20, where the first multimedia file is of a consumer product, and the second multimedia file is up-to-date pricing of the consumer product.

22. The multimedia system according to claim 17, further including a network between the CRM and the host server for communicating between each other.

23. A multimedia system capable of providing faster access to multimedia files, comprising:
a host server adapted to communicate with a client readable medium (CRM) that is capable of reading a portable storage medium (PSM) having local multimedia files adapted to interact with remote data that corresponds with a media identification (MID) information, where the host server initializes a plurality of autonomous media objects (AMOs) using the remote data and embeds the AMOs into a compound multimedia presentation.

24. The multimedia system according to claim 23, where the remote data is stored in a database.
